(19) United States
(12) Patent Application Publication
(10) Pub. No.: US 2010/0299759 A1
(43) Pub. Date: Nov. 25, 2010

(54) DIGITAL INFORMATION SECURITY SYSTEM, KERNAL DRIVER APPARATUS AND DIGITAL INFORMATION SECURITY METHOD

(75) Inventors: Jong Young Kim, Seoul (KR); Sung Won Cho, Incheon (KR); Dong Uk Lee, Seoul (KR); Jong Uk Choi, Seoul (KR)

Correspondence Address: OCCHIUTI ROHLICEK & TSAO, LLP, 10 FAWCETT STREET, CAMBRIDGE, MA, 02138, US

(73) Assignee: MARKANY INC., SEOUL (KR)

(21) Appl. No.: 12/745,990

(22) PCT Filed: Nov. 13, 2008
(86) PCT No.: PCT/KR08/06689

§ 371 Date: Aug. 5, 2010

(30) Foreign Application Priority Data
Dec. 7, 2007 (KR) 10-2007-0126689

(51) Int. Cl. G06F 21/22

(52) U.S. Cl. 726/28; 726/27; 726/30

(57) ABSTRACT

Disclosed herein are a digital information security system, a kernel driver apparatus, and a digital information security method. The digital information security system includes a user module configured to operate in a user mode and to provide environment setting information comprising policy information about a use of digital information, and a kernel driver configured to operate in a kernel mode, to acquire information generated by an application of the user mode for the use of digital information, and to perform rights control regarding the use of digital information based on the acquired information and the policy information. Accordingly, the construction of a security system can be simplified, and the security of a security system can be improved.

### TECHNICAL FIELD

The present invention relates to a digital information security system, a kernel driver apparatus, and a digital information security system, and more particularly, to digital information security technology, which is capable of performing the security of digital information through a common driver operating in a kernel mode.

### BACKGROUND ART

In recent years, with the development of digital technologies and the popularization of a super high-speed Internet service, document work environments, which were performed off line in the past, are abruptly replaced with on-line and digitalized work environments. In these digitalized work environments, digitalized digital information can be processed. The terminology ‘digital information’ generally refers to information, such as text documents and images, which can be written in a specific file form using an application.

Digital information can provide users with a high degree of convenience because it can be easily edited, saved, copied, etc. in view of its characteristics. For example, in terms of a business, a user can save time and improve his work efficiency, by editing, saving and copying a desired document in various forms using applications, such as Word and Worksheet.

However, such digital information can be easily exposed to illegal information flow and use because it can be copied unlimitedly even without loss of the information. Accordingly, in order to create a safe and reliable digital information business environment, security means for protecting digital information from illegal behaviors must be supported. The security means for protecting digital information may include a variety of kinds, such as encryption, flow prevention, and privilege control of digital information files.

Meanwhile, an environment in which a computer system is executed can be largely divided into two modes, that is, a user mode and a kernel mode. The user mode refers to a mode in which a user is allowed to directly see, manipulate and use information. For example, applications, such as Word, Worksheet, and Image Tool, are performed in the user mode. In contrast, the kernel mode is an execution mode at an operating system (OS) stage, which cannot be seen by a user. For example, process management, system management, disk management, memory management, and so on are performed in the kernel mode by a kernel. Applications of the user mode operate in an operating system of the kernel mode, and the kernel mode can process a variety of requests from the user mode.

Conventionally, security functions of digital information are performed in the user mode. For example, each application includes security modules for encryption of digital information, flow prevention and privilege control of digital information, etc. Encryption of digital information, flow prevention and privilege control of digital information, etc. are performed in the user mode in each application.

However, a conventional security system is problematic in that it has a very complicated structure and requires a lot of human resources and high cost in its maintenance because a unique security scheme is used every application. For example, in the case in which a number of applications exist in a computer system and the respective applications have different security modules, a structure for executing the security of digital information is very complicated and a very high cost for maintaining each security module is required. Further, a security scheme performed in the user mode is problematic in that it is vulnerable to external vicious attack.

### DISCLOSURE OF INVENTION

### Technical Problem

Accordingly, the present invention has been made in view of the above problems, and it is an object of the present invention to improve the efficiency and security of a system construction by providing a digital information security system which performs security functions through a kernel driver operating in a kernel mode.

It is another object of the present invention to provide a kernel driver apparatus which performs rights control by acquiring information from an application program interface (API) and file inputs/outputs (I/Os), which are generated by applications.

It is still another object of the present invention to provide a digital information security method of driving a kernel driver and its security function modules so that rights control on the use of digital information can be performed.

It is further still another object of the present invention to provide a digital information security method, which is capable of controlling screen capturing, clipboard copy, printing, file use rights, etc. of digital information using a kernel driver.

### Technical Solution

To achieve the above objects, according to an aspect of the present invention, there is provided a digital information security system. The digital information security system includes a user module configured to operate in a user mode and to provide environment setting information may comprise policy information about a use of digital information, and a kernel driver configured to operate in a kernel mode, to acquire information, generated by an application of the user mode for the use of digital information, and to perform rights control regarding the use of digital information based on the acquired information and the policy information.

The user module may comprise a digital rights management (DRM) agent for storing environment setting information, received from a DRM server, in a local repository and controlling the driving of the kernel driver, and a digital information manager configured to be inserted into the application by the DRM agent and to manage the policy information based on the stored environment setting information.

The DRM agent may comprise a user authentication module for authenticating a user in association with the DRM server, an environment setting module for receiving environment setting information of the user, authenticated by the user authentication module, from the DRM server and storing the received environment setting information in the local repository, a digital information manager injection module for, when a notice, informing creation of a process, is received from the kernel driver, injecting the digital information manager into the process, and providing an injection result and its pertinent information to the kernel driver, and a driver control module for controlling the driving of the kernel driver.

The policy information included in the environment setting information may comprise access control information of the authenticated user. Here, the access control information may comprise at least any one of access rights of digital information accessible to the authenticated user for every application, a screen capturing prevention policy, a clipboard use policy, and a print policy.

The digital information manager injection module may provide at least any one of a process identifier, a process-based automatic encryption value, a process-based screen capturing prevention value, a process-based clipboard control value, and a process-based print control value to the kernel driver.

The driver control module may control at least any one of load/unloading of the kernel driver, set/clear of the kernel driver, and activation/deactivation of a specific function of the kernel driver. Further, the driver control module may provide the kernel driver with at least any one of user information and policy information, an encryption-excepted extension name, a file header encryption/decryption key, and a file header encryption/decryption public key.

The digital information manager may comprise a user information/policy management module for acquiring data from the environment setting information stored in the local repository, managing the acquired data, and performing a user information and a policy inquiry processing at the request of a specific module, a header management module for analyzing the header of an encrypted file or creating the header of a file to be encrypted at the request of the kernel driver, and performing a file information and policy inquiry processing at the request of the specific module, an access control information management module for requesting information from the user information/policy management module and the header management module, and determining a policy depending on the request of the kernel driver based on information received in response to the request, and a communication module for accessing the kernel driver and providing a communication function with the kernel driver. Here, the access control information management module may record log information using log data received from the kernel driver.

The kernel driver may comprise a kernel application program interface (API) hooking/processing module for, when a system call kernel API requiring rights control is generated by the application, hooking the system call kernel API and performing rights control based on the policy information, and a file system hooking/processing module for hooking file inputs/outputs (I/Os) generated by the application and performing encryption or decryption of a corresponding file based on the policy information.

The kernel API hooking/processing module may comprise a screen capturing prevention module for hooking a system call kernel API generated by the application in connection with screen capturing and performing a capturing prevention processing based on the policy information by inquiring the policy information, and a clipboard copy prevention module for hooking a system call kernel API generated by the application in connection with clipboard copy and performing a clipboard copy prevention processing based on the policy information by inquiring the policy information, and a print control module for hooking a system call kernel API generated by the application in connection with printing and controlling whether to perform the printing based on the policy information by inquiring the policy information.

Further, the kernel API hooking/processing module may comprise a Watermark injection module for hooking a system call kernel API generated by the application in order to inject a Watermark during a print process, inquiring the policy information, and, if the Watermark needs to be injected, injecting the Watermark into a print output result, and a print file information writing module for requesting the user module to write log information upon printing.

Meanwhile, the kernel driver may comprise a file system hooking/processing module for hooking file I/Os generated by the application and encrypting or decrypting the corresponding file.

The file system hooking/processing module may comprise a context management module for performing registration, inquiry, and deletion functions of context for analysis of file I/Os and an encryption processing of files, a file header management module for requesting a policy pertinent to a use of a file from the user module and performing a function of managing a header of a file, and a file system hooking/processing routine module for acquiring file I/Os other than file I/Os having support-excepted extensions, while hooking and filtering file I/Os generated by the application, and performing encryption or decryption of files pertinent to the acquired file I/Os.

The file header management module may comprise at least any one of a header decryption function of decrypting an encrypted file, a header encryption function of encrypting a plaintext file, and a file analysis function of determining a type of a file through file analysis. Further, the file header management module may create a data encryption key used to encrypt a file.

The kernel driver may comprise a control module for activating or deactivating at least any one of the kernel API hooking/processing module and the file system hooking/processing module in response to a control signal received from the user module, a communication module for accessing the user module and providing a communication function with the user module, and a policy POOL for storing information necessary for operations of the kernel API hooking/processing module and the file system hooking/processing module and providing the information at the request of the kernel API hooking/processing module and the file system hooking/processing module.

The control module may register the information necessary for the operations of the kernel API hooking/processing module and the file system hooking/processing module with the policy POOL or delete information from the policy POOL. The information may comprise the policy information. Further, when a process is created by the application, the control module may transmit a notice, informing the creation of the process, to the user module and register process information, received from the user module, with the policy POOL.

Meanwhile, to achieve the above objects, according to another aspect of the present invention, there is provided a kernel driver apparatus for performing rights control in a kernel mode. The kernel driver apparatus comprises a storage module for storing information, a control module for receiving setting information, including policy information, from a specific entity of a user mode and registering the received setting information with the storage module, and a security function module for hooking information, generated by an application of the user mode for a use digital information and performing rights control regarding the use of the digital information using at least any one of policy information, registered with the storage module, and policy information managed in the application.

Here, the information generated in the kernel mode in order to use the digital information may comprise at least any one of a system call kernel API and file I/Os, generated by the application.

The security function module may comprise at least any one of a kernel API hooking/processing module for hooking the system call kernel API generated by the application and performing rights control based on the policy information, and a file system hooking/processing module for hooking the file I/Os generated by the application and performing encryption or decryption of a corresponding file based on the policy information. Here, the rights control nay control at least any one of file open, file edit, file storage, file printing, screen capturing, and clipboard copy of the digital information.

Meanwhile, to achieve the above objects, according to still another aspect of the present invention, there is provided a digital information security method. The digital information security method comprises the steps of receiving environment setting information from a DRM server and storing the received environment setting information in a local repository, loading a kernel driver for performing rights control, providing the kernel driver with setting information necessary for an operation of the kernel driver based on the environment setting information, and when the kernel driver is set according to the setting information, activating at least one of security function modules included in the kernel driver.

The digital information security method may further comprise the steps of when a notice, informing creation of a process, is received from the kernel driver, injecting a digital information manager into the corresponding process, providing the kernel driver with an injection result in the injection step and its pertinent information, and the kernel driver performing rights control through a security function module in association with the digital information manager.

The security function module may control at least any one of file open, file edit, file storage, file printing, screen capturing, and clipboard copy of digital information.

Meanwhile, to achieve the above objects, according to further still another aspect of the present invention, there is provided a digital information security method using a kernel driver operating in a kernel mode. The digital information security method comprises the steps of hooking an API generated by an application of a user mode, wherein the API is pertinent to a use of digital information, determining whether rights control regarding the use of digital information is necessary by inquiring preset policy information, and, if, as a result of the determination, the rights control is determined to be required, controlling use rights of the digital information based on the policy information.

The step of hooking the API may comprise the step of hooking the API generated by the application of the user mode for the purpose of screen capturing of the digital information. In this case, the step of controlling the use rights of the digital information may comprise the step of performing a screen capturing prevention processing for preventing the screen capturing of the digital information.

The step of hooking the API may comprise the step of hooking the API generated by the application of the user mode in order to copy at least part of the digital information to a clipboard. In this case, the step of controlling the use rights of the digital information may comprise the steps of prohibiting the copy to the clipboard and outputting a message, informing that the copy has not been permitted.

Meanwhile, the step of hooking the API may comprise the step of hooking the API generated by the application of the user mode in order to request printing of the digital information. In this case, the step of determining whether the rights control is necessary may comprise the steps of requesting a print policy of a user from a digital information manager injected into the application and receiving the print policy from the digital information manager. Further, the step of controlling the use rights of the digital information may comprise the step of performing or prohibiting the printing of the digital information based on the received print policy.

Meanwhile, to achieve the above objects, according to further still another aspect of the present invention, there is provided a digital information security method using a kernel driver operating in a kernel mode. The digital information security method comprises the steps of acquiring a specific file I/O by filtering file I/Os generated by an application of a user mode, analyzing a file of the acquired file I/O, and, if, as a result of the analysis, the file is an encrypted file, decrypting a header of the file and then requesting a policy for rights control from a digital information manager of the user mode, and, if, as a result of the analysis, the file is a plaintext file, creating a data encryption key for encrypting the file and then requesting at least any one of a header of the file and a policy for rights control of the file from the digital information manager.

### ADVANTAGEOUS EFFECTS

As described above, according to the present invention, major security operations for protecting digital information are performed through a kernel driver. Accordingly, unlike in the prior art in which each security means is used in each application in a user mode, the common functions of security means provided in respective applications are configured in a kernel area as a common apparatus. Accordingly, the efficiency of a system construction can be significantly improved. Further, there is an advantage in that security can be improved because security functions are performed in a kernel area.

### BRIEF DESCRIPTION OF DRAWINGS

FIG. 1 is a block diagram showing the schematic construction of a digital information security system according to a preferred embodiment of the present invention;

FIG. 2 is a block diagram showing the detailed construction of the digital information security system according to a preferred embodiment of the present invention;

FIG. 3 is a block diagram showing the detailed construction of a kernel API hooking/processing module shown in FIG. 2;

FIG. 4 is a block diagram showing the construction of a file system hooking/processing module shown in FIG. 2;

FIG. 5 is a flowchart illustrating a digital information security method according to a preferred embodiment of the present invention;

FIG. 6 is a flowchart illustrating a screen capturing prevention procedure using a kernel driver of the digital information security system;

FIG. 7 is a flowchart illustrating a clipboard copy prevention procedure using the kernel driver of the digital information security system;

FIG. 8 is a flowchart illustrating a print control procedure using the kernel driver of the digital information security system;

FIG. 9 is a flowchart illustrating an open procedure of an encryption file using the digital information security system;

FIG. 10 is a flowchart illustrating an open procedure of a plaintext file using the digital information security system;

FIG. 11 is a flowchart illustrating a procedure of creating a new file using the digital information security system;

FIG. 12 is a flowchart illustrating a procedure of reading a file using the digital information security system; and

FIG. 13 is a flowchart illustrating a procedure of writing a file using the digital information security system.

### DESCRIPTION OF REFERENCE NUMERALS OF PRINCIPAL ELEMENTS IN THE DRAWINGS

10: DRM server

20: computer system

30: digital information security system

40: application

100: user module

110: DRM agent

112: user authentication module

114: environment setting module

116: digital information manager injection module

118: driver control module

120: digital information manager

122: user information/policy management module

124: header management module

126: access control information management module

128: communication module of digital information manager

200: kernel driver

210: control module

220: communication module of kernel driver

230: policy POOL

240: kernel API hooking/processing module

250: file system hooking/processing module

### MODE FOR THE INVENTION

Hereinafter, the present invention will be described in detail in connection with preferred embodiments with reference to the accompanying writings in order for those skilled in the art to be able to implement the invention. In the preferred embodiments of the present invention, specific technical terminologies are used for clarity of the content. However, it is to be understood that the present invention is not limited to specific selected terminologies and each specific term includes all technical synonyms operating in a similar way in order to accomplish a similar object.

First, in the present invention, the term ‘digital information’ may include all files, for example, text documents, images, sound sources, moving pictures, and multimedia, which can be opened, edited, or stored by a user. Further, the term the ‘use of digital information’ may refer to, in a wide sense, a behavior for draining and using digital information, such as screen capturing and clipboard copy of digital information as well as opening, edit, storage, and printing of digital information.

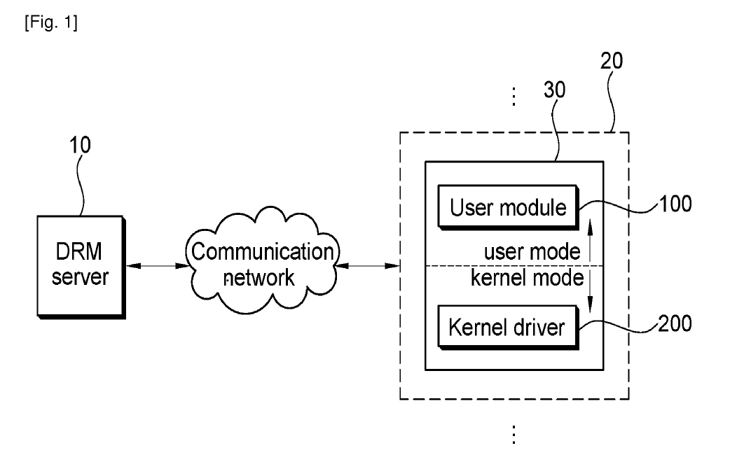

FIG. 1 is a block diagram showing the schematic construction of a digital information security system according to a preferred embodiment of the present invention.

The digital information security system 30 according to a preferred embodiment of the present invention may be provided in a computer system 20 and may be configured to operate in conjunction with a digital rights management (DRM) server 10 over a local network or a wide area network, as shown in FIG. 1. The DRM server 10 is a security server for providing user authentication, environment setting information of a user, etc. and may be provided in the form of an in-house security server in a local network or may be provided in a wide area network, such as the Internet.

The digital information security system 30 includes a user module 100 and a kernel driver 200. The user module 100 may be executed in a user mode, and the kernel driver 200 may be executed in a kernel mode. That is, the user module 100 may be provided in the user stage of the computer system 20, and the kernel driver 200 may be provided in the kernel stage of the computer system 20.

The user module 100 provides environment setting information, such as policy information about the use of digital information by a user. The kernel driver 200 acquires information generated by applications in order to use digital information and performs rights control on the use of digital information based on the acquired information and policy information.

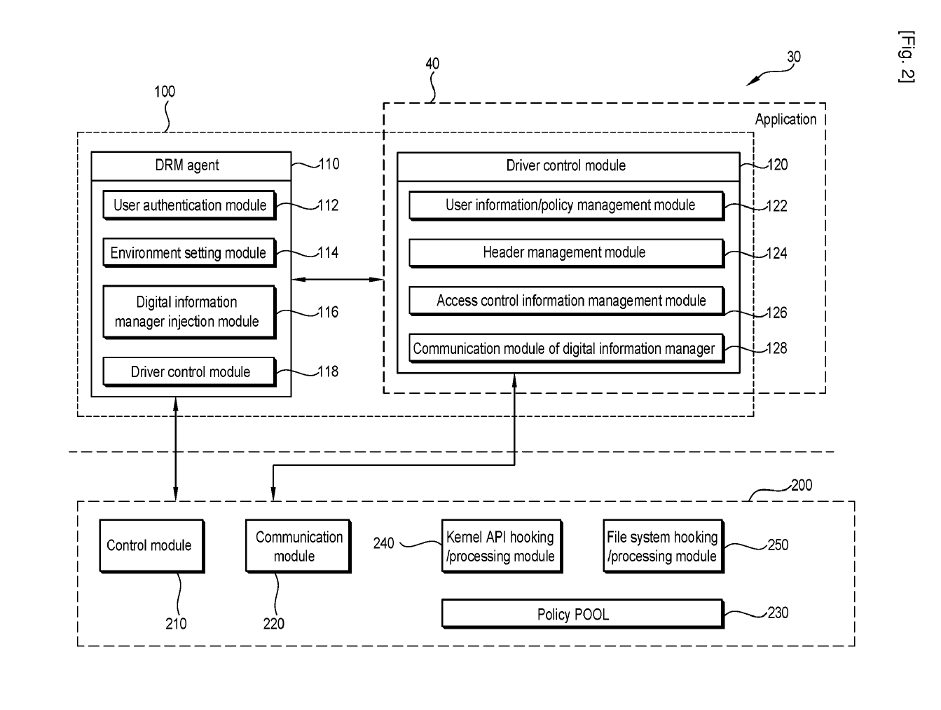

The detailed construction of the digital information security system 30 is shown in FIG. 2. Each of the elements of the digital information security system 30 is described below in detail with reference to FIG. 2.

The user module 100 of the digital information security system 30 includes, as shown in FIG. 2, a DRM agent 110 and a digital information manager 120. The digital information manager 120 may be provided within an application 40 by the DRM agent 110.

1. User Module 100

i. DRM Agent 110

The DRM agent 110 functions to provide a user authentication function in association with the DRM server 10 and to synchronize user environment setting information of the DRM server 10 with local environment setting information. The DRM agent 110 also functions to inject the digital information manager 120 into a process of the application 40, to provide its pertinent information to the kernel driver 200, and to control load/unloading and set/clear of the kernel driver 200 or activation/deactivation of a specific function.

The DRM agent 110 may include a user authentication module 112, an environment setting module 114, a digital information manager injection module 116, and a driver control module 118.

The user authentication module 112 performs a user authentication function. For example, the user authentication module 112 may provide a user with a user interface, receive user registration information (for example, an ID and a password) from a user, and transmit the input user registration information to the DRM server 10. The user authentication module 112 may receive authentication results from the DRM server 10 and may perform user authentication depending on the received authentication results. Here, the user authentication module 112 may inform the user whether the authentication is successful or not and, if the authentication is unsuccessful, request the user to input new user registration information.

The environment setting module 114 functions to receive environment setting information, corresponding to an authenticated user, from the DRM server 10 if user authentication is successful and to store the received environment setting information in a local repository, such as the hard disk of the computer system 20. In other words, the environment setting module 114 functions to synchronize the user environment setting information of the DRM server 10 with local user environment setting information.

The environment setting information may include various pieces of information necessary for rights control, such as various pieces of policy information, user information, and service system information. The policy information may refer to access control information of a user, which is assigned to the corresponding user. The access control information may include information defined as to whether which access rights (for example, whether a user is permitted to open, save, or print a file) for each application does a user have, information including a screen capturing prevention policy, a clipboard use policy, and a print policy, etc. Further, the service system information may refer to information pertinent to an in-house system in which a system (for example, the digital information security system 30), which provides a digital information security service, is constructed. The service system information may include a digital information exchange policy, a public key value, etc. for each service system, which are necessary to transmit digital information to other service systems or receive digital information from other service systems.

The digital information manager injection module 116 injects the digital information manager 120 into a process in response to a notice, informing the creation of the process, which is received from the kernel driver 200, and provides an injection result and its pertinent information to the kernel driver 200. For example, the digital information manager injection module 116 may receive a notice, informing the creation of a process, from the kernel driver 200 in the state in which an additional thread for injecting the digital information manager 120 is driven, determine whether the process is a supportable process, and, if, as a result of the determination, the process is determined to be a supportable process, inject the digital information manager 120 into the process. The digital information manager injection module 116 then transfers the injection result and its pertinent information to the kernel driver 200. The term ‘process’ may refer to a processing task performed by the application 40. A plurality of processes may be created in one application 40. Information about the process is typically managed in an operating system, such as Windows.

The digital information manager injection module 116 may provide the following process information to the kernel driver 200.

1) Process identifier: an ID or handle of a process.

2) Process-based automatic encryption value: an automatic encryption value for a file created through a process or a digital information file opened through a process.

3) Process-based screen capturing prevention value: a capturing prevention value for performing control on a screen capturing function, such as a screen capturing tool.

4) Process-based clipboard control value: a control value for performing control on a copy function of data using clipboard.

5) Process-based print control value: a value for performing print control

Meanwhile, the driver control module 118 performs control functions for driving the kernel driver 200. To this end, the driver control module 118 may operate in conjunction with the control module 210 of the kernel driver 200 and apply a control signal to the control module 210 of the kernel driver 200.

The driver control module 118 may control, for example, the load/unloading and set/clear of the kernel driver 200, and the activation/deactivation of a specific function. Each of the functions is described below in detail.

First, the driver control module 118 may function to load the kernel driver 200, operating in a kernel mode, on memory so that the kernel driver 200 is executed or may unload the kernel driver 200, which is being executed, so that the kernel driver 200 is terminated (a load/unloading function).

The driver control module 118 may also set a set value necessary for the kernel driver 200 or delete set data using environment setting information received from the DRM server 10 when a user is authenticated (a driver set/clear function). The set value necessary when the kernel driver 200 is set is as follow.

1) User information and policy information (for example, access control information, a screen capturing prevention policy, a clipboard use policy, and a print policy).

2) List of encryption-excepted extension names (for example, a list of extensions of files which have not been encrypted, such as EXE, DLL, OCX, and SYS).

3) File header encryption/decryption key: file header encryption/decryption key values of digital information use key values, which are differently created in the DRM server 10 depending on the exchange range of digital information.

4) File header encryption/decryption public key: this key is used to support a digital information exchange policy for every service system. The file header encryption/decryption public key is used to use only one public key value when the header of digital information is encrypted in order to analyze the header, in the case where the digital information is sent to another service system or the digital information is received from another service system. In other words, the reason why the public key is used is that, in the case where digital information is transmitted to another service system, the corresponding service system must be able to decrypt the digital information, and in the case where digital information is received from another service system, the received digital information must be able to be decrypted.

The driver control module 118 may also function to activate or deactivate a specific function by activating or deactivating a specific module, such as the kernel API hooking/processing module 240 or the file system hooking/processing module 250 of the kernel driver 200, in association with the control module 210 of the kernel driver 200 (a function of activating or deactivating a specific function).

In order for the kernel driver 200 to hook an API and perform a security processing on the API when the API is called by the application 40, the kernel API hooking/processing module 240 must have been activated. The driver control module 118 may activate the kernel API hooking/processing module 240 by applying a kernel API hooking activation control signal to the control module 210 of the kernel driver 200. On the contrary, in the case where hooking and a security processing for an API call should not be performed by the application 40 because of a user logout, etc., the driver control module 118 may deactivate the kernel API hooking/processing module 240 by applying a kernel API hooking deactivation control signal to the control module 210 of the kernel driver 200.

In the same manner, in order to perform an encryption processing on file I/Os generated by the application 40, the file system hooking/processing module 250 must have been activated. The driver control module 118 may activate the file system hooking/processing module 250 by applying a file system hooking activation control signal to the control module 210 of the kernel driver 200. However, in the case where encryption for file I/Os generated by the application 40 is not necessary because of a user logout, etc., the driver control module 118 may deactivate the file system hooking/processing module 250 by applying a file system hooking deactivation control signal to the control module 210 of the kernel driver 200.

ii. Digital Information Manager 120

The digital information manager 120 is a module, injected into a process of the application 40 by the DRM agent 110, and is chiefly responsible for a policy control function. In particular, the digital information manager 120 may perform policy control based on environment setting information, provided by the DRM agent 110, and header information, received from the file system hooking/processing module 250.

The digital information manager 120 may include a user information/policy management module 122, a header management module 124, an access control information management module 126, and a communication module 128.

The user information/policy management module 122 acquires data from environment setting information stored in a local repository, such as a hard disk, manages the acquired data, and performs a processing for user information and a policy inquiry at the request of the access control information management module 126. For example, the user information/policy management module 122 may acquire data from environment setting information stored in a local repository(the environment setting information may be synchronized with user environment setting information of the DRM server 10 by the DRM agent 110) and store the acquired data in a specific area of memory. The user information/policy management module 122 may also perform a function of inquiring requested user information and a requested policy from a user s environment setting information, stored in a specific area of memory, at the request of the access control information management module 126.

The header management module 124 may perform a function of analyzing the header of an encrypted file received from the file system hooking/processing module 250 of the kernel driver 200 or creating the header of a file to be encrypted. The header management module 124 performs a processing for file information and policy inquiry at the request of the access control information management module 126. For example, in the event of a file that will be newly encrypted, if the file system hooking/processing module 250 requests the header of the file, the header management module 124 creates a new header, including a data encryption/decryption key of the file, file information/a policy of the file, and so on. Further, if the file system hooking/processing module 250 transmits the header of an encrypted file to the header management module 124 in order to decrypt the encrypted file, the header management module 124 analyzes the header of the encrypted file and registers information and a policy of the corresponding file with a policy database. The header management module 124 may also function to inquire information and a policy of a requested file, stored in a policy database, by analyzing the header of the requested file at the request of the access control information management module 126.

The access control information management module 126 manages an open policy, a save policy, a print policy, etc. for a file based on user information and a policy and header information and policy and performs a corresponding log writing processing. For example, the access control information management module 126 may request the user information/policy management module 122 or the header management module 124 to provide information thereto and determine an open policy, a save policy, a print policy, etc. from the kernel driver 200 based on information, such as user information and a policy and file information and policy provided in response the request. The access control information management module 126 may also record log information using log data received from the kernel API hooking/processing module 240 or the file system hooking/processing module 250 and transmit the corresponding log information to the DRM server 10 or temporarily store the corresponding log information in a local repository in the form of a database.

The communication module 128 accesses the communication module 220 of the kernel driver 200 and provides a communication function between the digital information manager 120 and the kernel driver 200. That is, the digital information manager 120 and the kernel driver 200 may exchange data with each other through the communication modules 128 and 220 respectively installed in the digital information manager 120 and the kernel driver 200.

The communication module 128 may perform a response to a policy request from the kernel API hooking/processing module 240 or the file system hooking/processing module 250 of the kernel driver 200 and communications, such as header data transmission and log data transmission. For example, the communication module 128 may perform functions, such as a response to the file print policy of the kernel API hooking/processing module 240, which has been determined by the access control information management module 126, a response to the open or save policy of the file system hooking/processing module 250, and the transmission of a file encryption/decryption key. The communication module 128 may also transfer the header of a file, which has been created by the header management module 124, to the kernel API hooking/processing module 240 at the request of the kernel API hooking/processing module 240.

2. Kernel Driver 200

The kernel driver 200 may include the control module 210, operating in a kernel mode, and may perform a variety of control functions of performing the kernel driver 200, the communication module 220 responsible for communications with the user module 100, a policy POOL 230, the kernel API hooking/processing module 240 for hooking a system call kernel API called by the application 40 and performing a security processing on the API, and the file system hooking/processing module 250 for hooking file I/Os generated by the application 40 and performing encryption/decryption for the files. Here, the kernel API hooking/processing module 240 and the file system hooking/processing module 250 may be said to be security function modules that substantially perform rights control.

The control module 210 performs an activation/deactivation function of activating/deactivating a specific function of the kernel driver 200. To this end, the control module 210 may operate in conjunction with the DRM agent 110. For example, the control module 210 may function to set a global variable of the kernel driver 200 in response to a control signal from the DRM agent 110 and may change the kernel API hooking/processing module 240 or the file system hooking/processing module 250 of the kernel driver 200 to an activation or deactivation status.

The control module 210 may also perform a policy POOL setting registration/deletion function of registering or deleting information with or from the policy POOL 230. For example, if user authentication has been performed in the DRM agent 110, the control module 210 may receive user information and policy information, a list of encryption-excepted extension names, a file header encryption/decryption key, a file header encryption/decryption public key, etc. from the DRM agent 110 and register them with the policy POOL 230. The pieces of registered information have already been described in connection with the above-described driver control module 118. If a user logout has been performed by the DRM agent 110, the control module 210 may receive a policy data clear request and may delete information stored in the policy POOL 230.

The control module 210 may perform a process creation detection function of detecting the creation and termination of processes performed by the application 40 included in the computer system 20. For example, the control module 210 may know whether any one support process is being executed or not by monitoring all processes, which are being executed and terminated in the computer system 20. Here, the support process may refer to a process that can be supported by the digital information security system 30. The control module 210 may store information about whether any one process is being executed so that the policy POOL 230 can inquire whether the process is being executed. Meanwhile, the control module 210 may receive an event, informing the creation and termination of processes from an operating system, such as Windows, in order to detect the creation and termination of the processes, and then set the status of a current process.

The control module 210 may also perform a process information registration function of detecting process information about a support process and registering the detected process information with the policy POOL 230. For example, if a support process is created, the control module 210 may notify the DRM agent 110 of the creation of the process and register process information, provided by the DRM agent 110 (that is, a process identifier, a process-based automatic encryption value, a process-based screen capturing prevention value, a process-based clipboard control value, and a process-based print control value), with the policy POOL 230. The pieces of process information provided by the DRM agent 110 have already been described above in connection with the digital information manager injection module 116.

The communication module 220 may perform a data transmission/reception function between the kernel driver 200 and the digital information manager 120 in association with the communication module 128 of the digital information manager 120. The communication module 220 may perform a policy request function, a header request function, a log transfer function, and so on.

For example, the communication module 220 may perform a policy request function of requesting the open or save policy of an encrypted file from the digital information manager 120 and receiving a response from the digital information manager 120, during an I/O operation for creating the encrypted file, or, when print rights control for every file is performed, transmitting information of a file, acquired from the kernel API hooking/processing module, to the digital information manager 120 and receiving its rights policy information therefrom. The communication module 220 may also perform a header request function of requesting a header, necessary to encrypt a file, from the digital information manager 120 and receiving new header data from the digital information manager 120. Further, the communication module 220 may perform a log transmission function of transmitting log information, which has been generated or created by the kernel API hooking/processing module 240 and the file system hooking/processing module 250, to the digital information manager 120 so that the digital information manager 120 can record the log information therein.

The policy POOL 230 may store information used in the kernel API hooking/processing module 240 or the file system hooking/processing module 250 and allows the kernel API hooking/processing module 240 or the file system hooking/processing module 250 to inquire the stored information.

For example, the policy POOL 230 may store user information and policy information, a list of encryption-excepted extension names, a file header encryption/decryption key, a file header encryption/decryption public key, a process identifier, a process-based automatic encryption value, a process-based screen capturing prevention value, a process-based clipboard control value, a process-based print control value, and the like. The pieces of information are registered by the control module 210 of the kernel driver 200 as described above.

If a system call kernel API pertinent to rights control is generated by the application 40, the kernel API hooking/processing module 240 performs rights control depending on a policy by hooking the corresponding system call kernel API. For example, the kernel API hooking/processing module 240 may perform rights control, such as the prevention of screen capturing, the prevention of clipboard copy, the prevention of printing, and the injection of a Watermark upon printing, depending on a pertinent policy by hooking a system call kernel API, which is called by the application 40 in connection with screen capturing, clipboard copy, printing or the like.

The application 40 must call the system call kernel API of a kernel area when using a function, such as screen capturing, clipboard copy, or printing. Accordingly, if this system call kernel API is hooked and control is performed using a policy, rights control having high security can be performed.

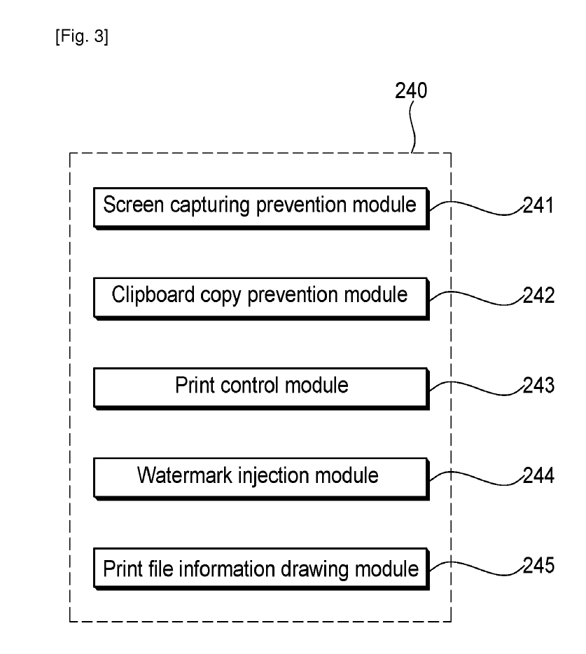

FIG. 3 is a block diagram showing the detailed construction of the kernel API hooking/processing module 240 shown in FIG. 2.

The kernel API hooking/processing module 240 may include, as shown in FIG. 3, a screen capturing prevention module 241, a clipboard copy prevention module 242, a print control module 243, a Watermark injection module 244, and a print file information writing module 245.

The screen capturing prevention module 241 hooks a system call kernel API, called by the application 40 in connection with screen capturing, inquires policy information, and performs rights control based on the policy information. For example, the screen capturing prevention module 241 may function to hook the system call kernel API of a kernel area corresponding to a user API (for example, BitBit), which is generated upon capturing of a screen, determine whether the API is a support process by inquiring the policy POOL 230, and, if the prevention of screen capturing is necessary, perform an adequate capturing prevention processing (for example, filling the entire captured screen with a specific color).

The clipboard copy prevention module 242 hooks a system call kernel API, which is called by the application 40 in connection with clipboard copy, inquires policy information, and performs rights control based on the policy information. For example, the clipboard copy prevention module 242 may hook a system call kernel API corresponding to a user API (for example, SetClipboardData), which is generated when a clipboard is copied and pasted, determine whether the API is a support process by inquiring the policy POOL 230, and, if the prevention of clipboard copy is necessary, prohibit the copy. Here, the clipboard copy prevention module 242 may also output a guidance message, indicating that copy is not permitted.

The print control module 243 hooks a system call kernel API, which is called by the application 40 in connection with printing, inquires policy information, and performs rights control based on the policy information. For example, the print control module 243 may hook a system call kernel API corresponding to a user API (for example, StartDoc), which is generated during a print process, search the digital information manager 120 for a print policy depending on a corresponding file, and, if a user does not have print rights for the file, and not allow the user to perform the print. The print rights may be determined in the form of various factors, such as user rights, the number of prints, a date limit, and the attribute of a file itself.

Information about a file to be printed may be obtained from a specific API (for example, ‘NtGdiStartDoc (one of APIs of Windows NT)), which belongs to the hooked system call kernel APIs. Accordingly, the print control module 243 may know whether the corresponding file can be printed, whether a Watermark has been injected or the like by requesting the digital information manager 120 to inquire the information. In this case, the digital information manager 120 may also transmit information about the form of a Watermark included in environment setting information, along with whether the Watermark has been injected or not. The type and position of the Watermark may vary depending on the information. Meanwhile, in order to inquire the print rights of a file, the print control module 243 may transmit a structure called ‘DOCFILEW’, which is one of the parameters of ‘NtGdiStartDoc’, to the digital information manager 120.

In order to inject a Watermark during a print process, the Watermark injection module 244 hooks a system call kernel API, which is generated by the application 40, inquires policy information, if, as a result of the inquiry, the policy information is digital information into which a Watermark must be injected, and injects the Watermark into a print output result. For example, in order to inject a Watermark during a print process, the Watermark injection module 244 may hook a system call kernel API corresponding to a generated user API (for example, TextOut), and, if information is digital information requiring the injection of the Watermark through information inquiry, injects the Watermark into a print output result according to a preset format. The contents of a Watermark may include a company logo, user information, file information, a print time, and the like.

The print file information writing module 245 requests the digital information manager 120 to write log information when printing is performed. When this request is made, the print file information writing module 245 also transmits information about a corresponding file so that the log information can be written and receives a message, indicating success or failure, from the digital information manager 120 in response thereto. Information included in the log information may include user information, printed file information, a print time, and the like.

The file system hooking/processing module 250 performs an encryption/decryption function, a context and header management function, and so on for file I/Os other than file I/Os having support-excepted extensions, while hooking and filtering file I/Os generated by the application 40.

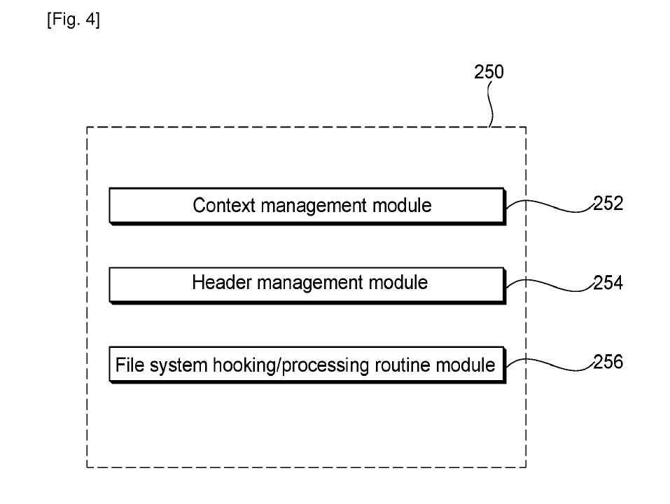

FIG. 4 is a block diagram showing the construction of the file system hooking/processing module 250 shown in FIG. 2.

The file system hooking/processing module 250 may include, as shown in FIG. 4, a context management module 252, a header management module 254, and a file system hooking/processing routine module 256.

The context management module 252 may perform a management function of a context for analyzing file I/Os and a file encryption/decryption processing, such as context registration, inquiry, and deletion.

For example, the context management module 252 may perform a context registration function of, when I/Os of a file are generated, requesting policy information from the digital information manager 120 and receiving information, indicating whether a user has an open rights for the file, from the digital information manager 120, and, if the user has the open rights, registering information pertinent to the file with a context. Here, the registered information pertinent to the file may include a process ID or handle, a file name, an open policy, a save policy, a data encryption key, and so on. The registered information pertinent to the file may be used when the file is decrypted or encrypted. The context management module 252 may also perform a context inquiry function of inquiring whether a context has been registered when a file is read or written. Meanwhile, when close/cleanup I/Os of a file are generated, the context management module 252 may perform a context deletion function of deleting a registered context for the corresponding file.

The header management module 254 may request the open/save policy of a file from the digital information manager 120 or perform header management for creating a header necessary for a file to be encrypted, key creation necessary for data encryption/decryption, and so on.

For example, the header management module 254 may perform a header decryption function of decrypting the header of a file using a header encryption/decryption key in order to request a policy from the digital information manager 120 when an encrypted file is decrypted. The header management module 254 may also perform a header encryption function of creating a new file for a plaintext file that has not been encrypted, encrypting a new header provided by the digital information manager 120, saving the new header in the form of meta data of the created new file, encrypting the plaintext data, writing the encrypted plaintext data in the created new file, deleting an existing file, and changing a name of the created new file to a name of the existing file.

The header management module 254 may also perform a file analysis function of determining whether a corresponding file is a newly created file, a plaintext file, or an encrypted file by reading the header of the corresponding file and then performing a header decryption processing. Meanwhile, the header management module 254 may also perform a data encryption/decryption key creation function of creating a key value, which will be used to encrypt a newly created file and a plaintext file, and a key creation processing of providing limited functions to a specific computer system.

The file system hooking/processing routine module 256 may perform an encryption/decryption function for file I/Os other than file I/Os, having support-excepted extensions, while hooking file I/Os generated by the application 40 in real time.

For example, the file system hooking/processing routine module 256 may perform a filtering function of searching file I/Os, generated in real time, for an encryption/decryption target file (for example, a digital information file). That is, the file system hooking/processing routine module 256 searches for a file I/O other than file I/Os, having support-excepted extensions, through filtering. In this case, a process ID and an exception extension list stored in the policy POOL may be used. The file system hooking/processing routine module 256 may also perform a decryption function of replacing a read data buffer with the header of an encrypted file and the sector size of a local repository (for example, a hard disk) taken into consideration with respect to read I/Os and decrypting read data using a data encryption/decryption key. The file system hooking/processing routine module 256 may also perform an encryption function of replacing a write data buffer with the header of an encrypted file and the sector size of a local repository (for example, a hard disk) taken into consideration with respect to write I/Os and encrypting data to be written using a data encryption/decryption key.

The file system hooking/processing routine module 256 may also perform a log information creation function of creating log information pertinent to the open, save, etc. of a file. The created log information may include, for example, a new file or plaintext file encryption log when a file is analyzed and a data encryption/decryption key is created, a storage log for a file when an encryption processing is performed, and a log for file open when a file is analyzed and a context is registered.

The construction of the digital information security system 30 according to a preferred embodiment of the present invention has been described above. The digital information security system 30 synchronizes environment setting information of a user and environment setting information of the DRM server 10 on a local and performs a rights control operation for digital information security through association of the user module 100 and the kernel driver 200. In particular, in the prior art, all operations for digital information security are performed in a user mode. In the digital information security system 30 of the present invention, however, the kernel driver 200 hooks pieces of information generated by the application 40, such as APIs or file I/Os, so substantial rights control can be performed in a kernel mode. Accordingly, a system structure can be further simplified, and security thereof can be significantly improved.

The present invention will now be described in terms of a methodology by describing operation procedures on the basis of the digital information security system 30.

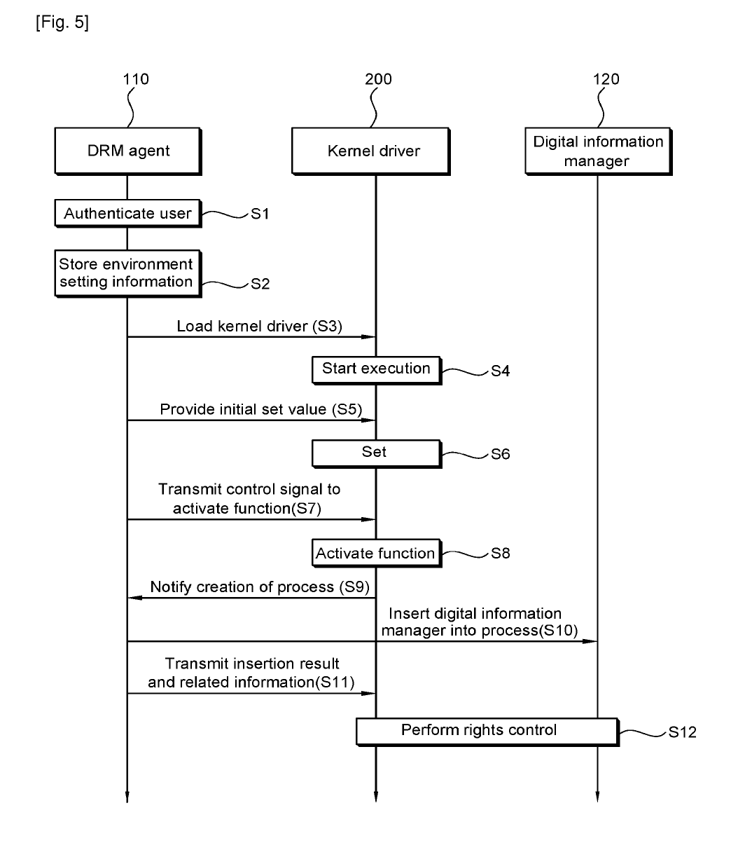

FIG. 5 is a flowchart illustrating a digital information security method according to a preferred embodiment of the present invention.

The DRM agent 110 first performs user authentication in association with the DRM server 10 (step: S1), as shown in FIG. 5. For example, the DRM agent 110 may provide a user interface through which the input of user registration information (for example, an ID and a password) is requested from a user and may transmit the input user registration information to the DRM server 10. The DRM agent 110 then authenticates the user depending on an authentication result received from the DRM server 10.

Next, the DRM agent 110 receives user environment setting information, corresponding to the authenticated user, from the DRM server 10 and stores the received environment setting information in a local repository (for example, a hard disk) (step: S2). The stored environment setting information is used for synchronization with local environment setting information. The environment setting information may include user information, policy information for rights control, service system information, and the like.

Next, the DRM agent 110 loads the kernel driver 200 on memory (step: S3), starts driving the kernel driver 200 (step: S4), and provides the kernel driver 200 with a set value necessary for the operation of the kernel driver 200 based on the environment setting information received from the DRM server 10 when user authentication is performed (step: S5).

The kernel driver 200 is set according to the received set value (step: S6). The set value necessary when the kernel driver 200 is set may include user information and policy information, a list of encryption-excepted extension names, a file header encryption/decryption key, and a file header encryption/decryption public key.

The DRM agent 110 may apply a control signal, instructing the activation of the kernel API hooking/processing function and the file system hooking/processing function to the kernel driver 200, in order to perform digital information security (step: S7). In response to the signal, the kernel driver 200 activates the kernel API hooking/processing function and the file system hooking/processing function and starts a rights control operation (step: S8).

The kernel driver 200 receives an event, which is pertinent to the creation and termination of a process, from an operating system, determines whether there is a support process based on the event, if, as a result of the determination, a support process is determined to exist, and transmits a signal to notify the creation of the process to the DRM agent 110 (step: S9). Accordingly, the DRM agent 110 injects the digital information manager 120 into the corresponding process (step: S10) and transmits an injection result and its pertinent information to the kernel driver 200 (step: S11). Here, the transmitted information may include a process identifier, an automatic encryption value of the corresponding process, a screen capturing prevention value of the corresponding process, a clipboard control value of the corresponding process, a print control value of the corresponding process, and so on. Meanwhile, the digital information manager 120 is configured to store environment setting information, stored in the local repository, in a specific area of the memory and is prepared to perform the above-described functions of the digital information manager 120.

Therefore, the kernel driver 200 may perform rights control while requesting necessary information from the digital information manager 120 (step: S12). For example, the kernel driver 200 may hook a system call kernel API for requesting a function pertinent to rights control when the system call kernel API is called by the application 40 that performs the process, inquiry policy information, and perform rights control based on the policy information. The kernel driver 200 may also hook file I/Os generated by the application 40 that performs the process and encrypt or decrypt a corresponding file with respect to file I/Os requiring encryption or decryption.

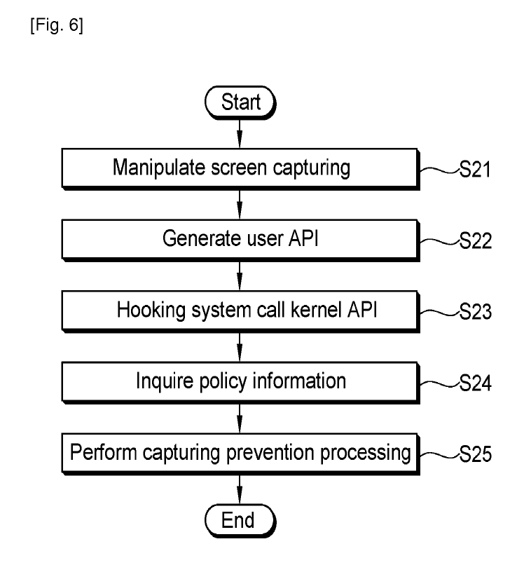

FIG. 6 is a flowchart illustrating a screen capturing prevention procedure using the kernel driver 200 of the digital information security system 30.

Referring to FIG. 6, first, in the state in which the screen capturing prevention function of the kernel API hooking/processing function of the kernel driver 200 has been activated, a user displays specific digital information on a screen using the application 40 and then captures the screen (step: S21).

At this time, the application 40 generates a user API for the screen capturing (step:

S22). In response to the generated user API, the kernel driver 200 hooks a system call kernel API corresponding to the user API generated by the application 40 (step: S23).

The kernel driver 200 then determines whether the process is a support process by inquiring preset policy information (for example, policy information stored in the policy POOL) (step: S24), and, if screen capturing prevention is required, performs a capturing prevention processing (step: S25). For example, the kernel driver 200 may perform a process of filling the entire captured screen with a specific color.

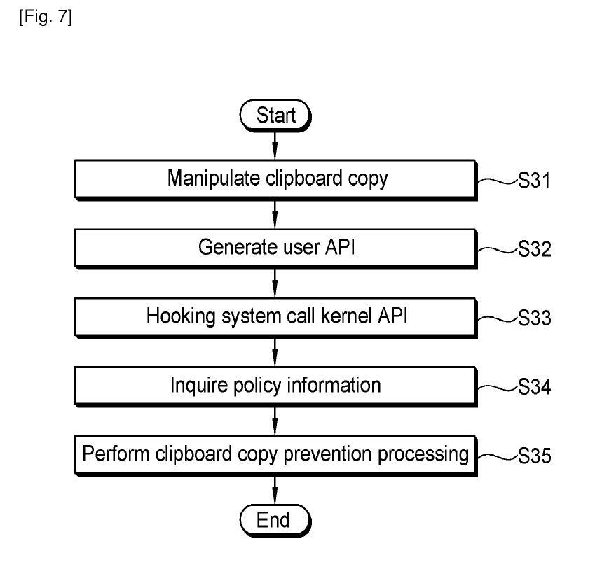

FIG. 7 is a flowchart illustrating a clipboard copy prevention procedure using the kernel driver 200 of the digital information security system 30.

Referring to FIG. 7, first, in the state in which the clipboard copy prevention function of the kernel API hooking/processing function of the kernel driver 200 has been activated, if a user displays specific digital information on a screen using the application 40 and then tries to copy at least a potion of the digital information to a clipboard (step: S31), the application 40 generates a user API for the clipboard copy (step: S32). In response thereto, the kernel driver 200 hooks a system call kernel API corresponding to the user API generated by the application 40 (step: S33).

The kernel driver 200 then determines whether the process is a support process by inquiring preset policy information (for example, policy information stored in the policy POOL) (step: S34), and, if the prevention of clipboard copy is required, prohibits the clipboard copy (step: S35). Here, the kernel driver 200 may let a user know that the clipboard copy has been prohibited by displaying a message, informing that the requested clipboard copy has been prohibited.

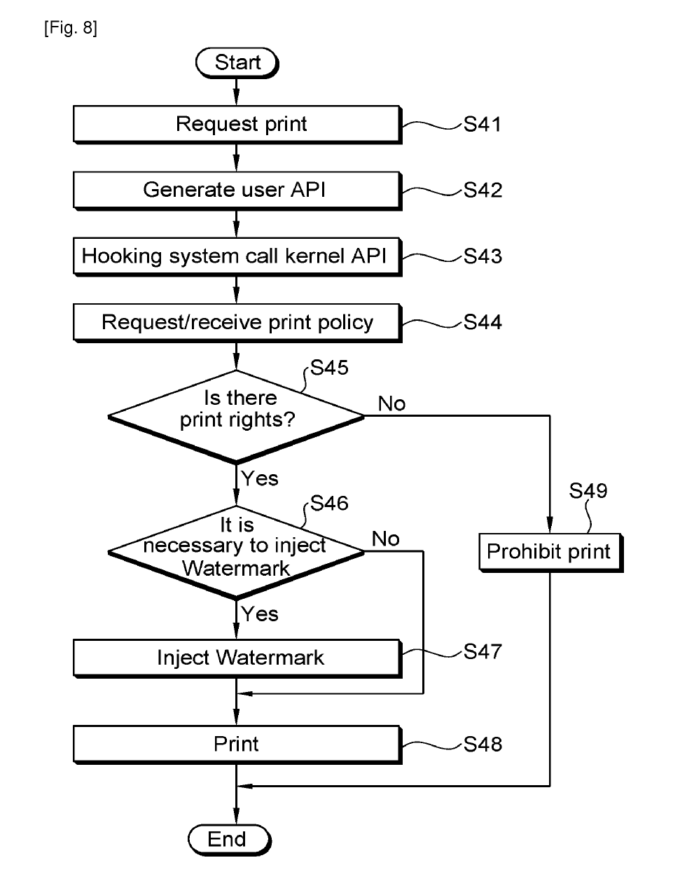

FIG. 8 is a flowchart illustrating a print control procedure using the kernel driver 200 of the digital information security system 30.

Referring to FIG. 8, it is first assumed that the digital information manager 120 has been inserted into a process performed by a user using the application 40 and the clipboard copy prevention function of the kernel driver 200 has been activated. The user displays specific digital information on a screen using the application 40 and then requests the digital information to be printed (step: S41).

At this time, the application 40 generates a user API for performing the requested print (step: S42). In response thereto, the kernel driver 200 hooks a system call kernel API corresponding to the generated API (step: S43).

The kernel driver 200 then requests a print policy (that is, rights information indicating whether printing is possible) of the user for the digital information from the digital information manager 120 and receives the requested print policy from the digital information manager 120 in response thereto (step: S44).

The kernel drive 200 performs the printing according to the received print policy or prohibits the printing (step: S45). For example, the kernel driver 200 may perform the printing only when the user has print rights for the digital information (step: S48). Here, if the injection of a Watermark is necessary (step: S46), a designated Watermark may be injected into the designated location of a print output result (step: S47). The designated information pertinent to the injection of the Watermark may be received from the digital information manager 120. However, if the user does not have print rights for the digital information, the printing is not permitted (step: S49).

Meanwhile, the process of injecting the Watermark into the print output result may be performed in a user mode. For example, when a user API is generated by the application 40, the digital information manager 120 may determine whether the Watermark must be injected and may then inject the Watermark into digital information.

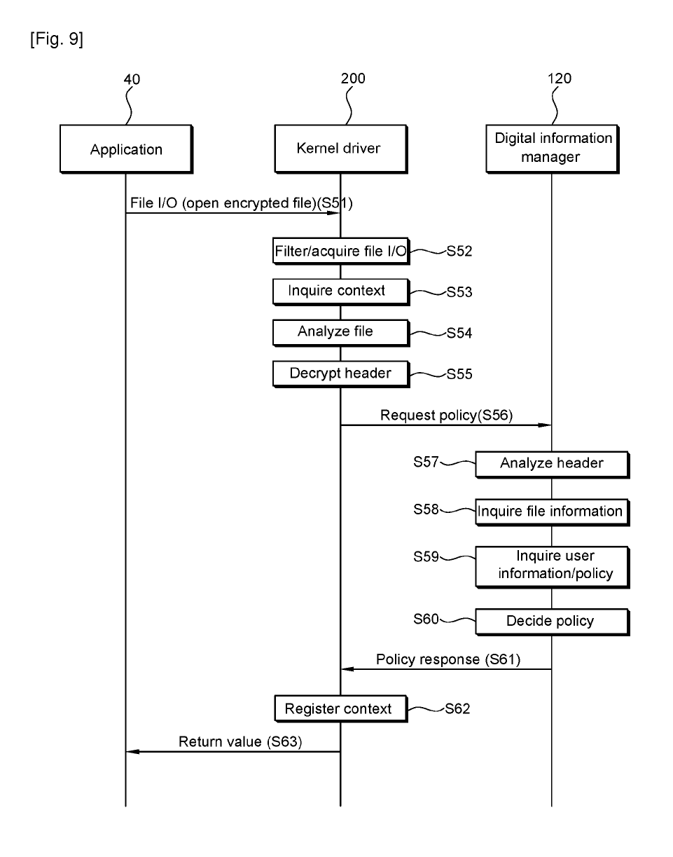

FIG. 9 is a flowchart illustrating a procedure of opening an encryption file using the digital information security system 30.

Referring to FIG. 9, the application 40 first generates a file I/O for opening a file (step: S51). The kernel driver 200 searches for and acquires the generated file I/O while consistently hooking and filtering file I/Os generated by the application 40 (step: S52).

The kernel driver 200 then inquires a context of the file (step: S53), recognizes that the file is an encrypted file by analyzing the file (step: S54), and decrypts a file header using the header encryption/decryption key (step: S55). The decryption of the file header has been described above in connection with the description of the header management module 254 of the kernel driver 200.

The kernel driver 200 then requests a policy for file open from the digital information manager 120 in order to determine whether to perform the opening of the file (step: S56). When a policy is requested, the file header may be transmitted.

The digital information manager 120 analyzes the file header received from the kernel driver 200 (step: S57) and decides a policy for the file open (step: S60) by inquiring file information, user information, and a policy (step: S58, S59). The digital information manager 120 then transmits the determined file open policy to the kernel driver 200 (step: S61). The kernel driver 200 receives the file open policy and registers the policy with context information (step: S62). The kernel driver 200 may then transmit a return value to the application 40 (step: S63).

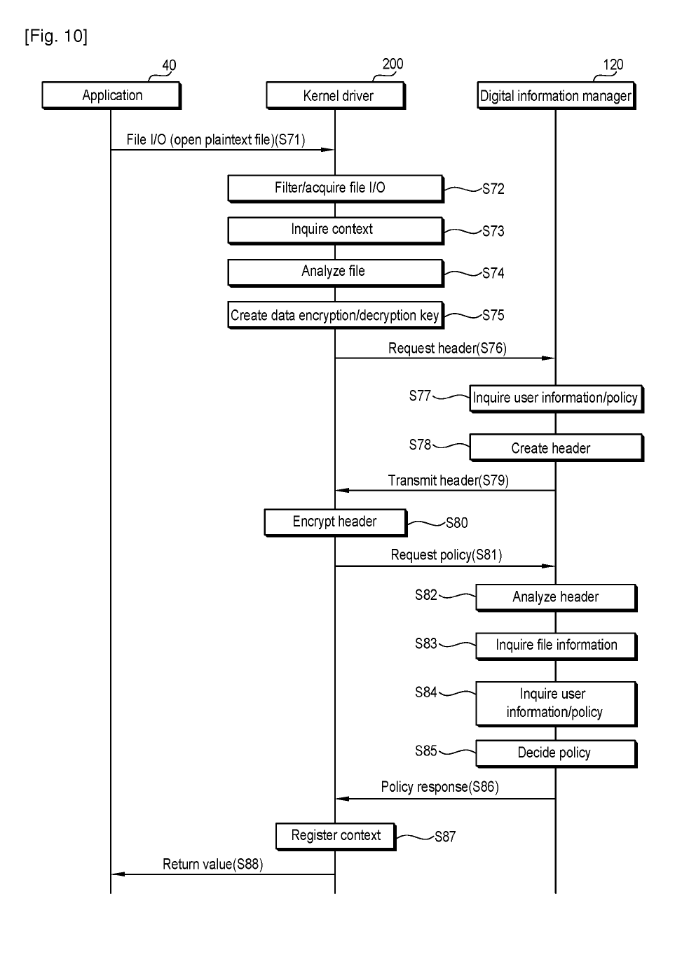

FIG. 10 is a flowchart illustrating an open procedure of a plaintext file using the digital information security system 30.

Referring to FIG. 10, the application 40 first generates a file I/O for opening a file (step: S71). The kernel driver 200 searches for and acquires the generated file I/O by continuously hooking and filtering file I/Os generated by the application 40 (step: S72).

The kernel driver 200 then inquires a context of the file (step: S73), recognizes that the file is a plaintext file by analyzing the file (step: S74), generates a data encryption/decryption key (step: S75), and then requests the digital information manager 120 to provide a header thereto (step: S76).

The digital information manager 120 inquires user information and a policy according to a request for the header from the kernel driver 200 (step: S77), generates a header including user information and a policy, a data encryption/decryption key of a file (step: S78), and then transmits the generated header to the kernel driver 200 (step: S79). The kernel driver 200 encrypts the received header (step: S80).

The kernel driver 200 then requests a policy for file open from the digital information manager 120 in order to determine whether to perform the opening of the file (step: S81). The digital information manager 120 analyzes the header of the file in response to the policy request (step: S82), inquires file information, and user information and a policy (step: S83, S84), and then determines a policy for the file open (step: S85). The digital information manager 120 transmits the determined file open policy to the kernel driver 200 (step: S86). The kernel driver 200 registers the received file open policy with context information (step: S87). The kernel driver 200 may then transmit a return value to the application 40 (step: S88).

Meanwhile, it has been described above that the kernel driver 200 creates a data encryption/decryption key, requests a header from the digital information manager 120, receives the header, encrypts the header, requests a policy from the digital information manager 120 again, and receives a response to the policy. However, the kernel driver 200 may create a data encryption/decryption key, request a header and a policy from the digital information manager 120 at the same time, and receive the header and the policy from the digital information manager 120 in response thereto, depending on implementation environments. In this case, the kernel driver 200 may perform encryption through a received header and then register a context.

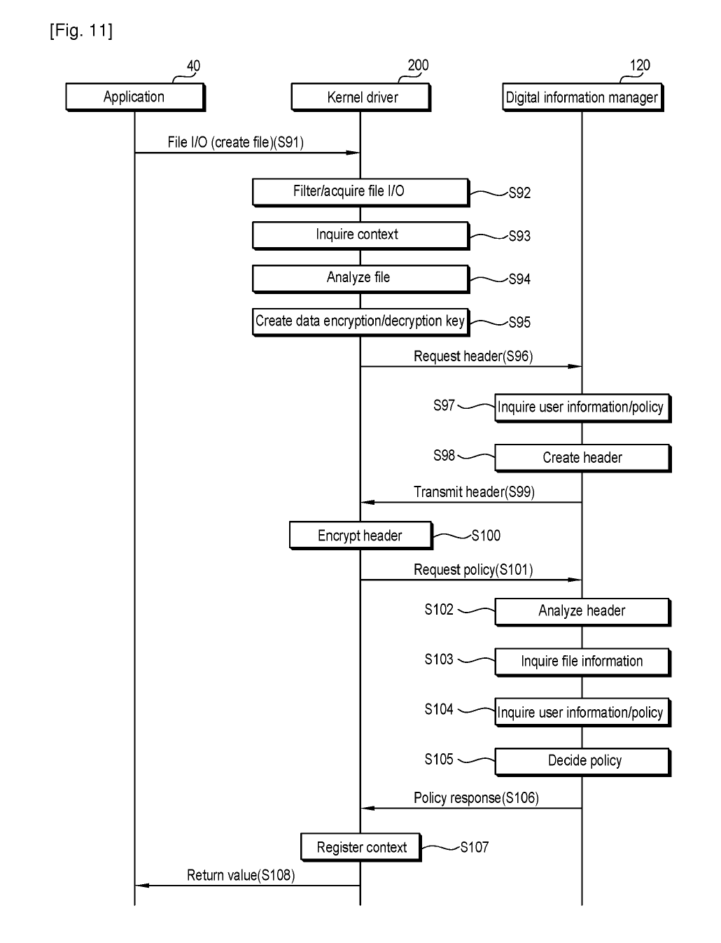

FIG. 11 is a flowchart illustrating a procedure of creating a new file using the digital information security system 30.

Referring to FIG. 11, the application 40 first generates a file I/O for creating a new file (step: S91). The kernel driver 200 searches for and acquires the generated file I/O by continuously hooking and filtering file I/Os generated by the application 40 (step: S92).

The kernel driver 200 then inquires a context of the file (step: S93), recognizes that the file is a newly created file by analyzing the file (step: S94), create a data encryption/decryption key (step: S95), and requests the digital information manager 120 to provide a header thereto (step: S96).

The digital information manager 120 inquires user information and a policy according to the request for the header from the kernel driver 200 (step: S97), creates a header including user information and a policy, and a data encryption/decryption key of the file (step: S98), and transmits the created header to the kernel driver 200 (step: S99). The kernel driver 200 encrypts the received header (step: S100).

The kernel driver 200 requests a policy for file open from the digital information manager 120 in order to determine whether to open the file (step: S101). The digital information manager 120 analyzes the header of the file in response to the policy request (step: S102), inquires file information, user information, and a policy (step: S103, S104), and determines a policy for the file open (step: S105). The digital information manager 120 transmits the determined file open policy to the kernel driver 200 (step: S106). The kernel driver 200 receives the file open policy and registers the policy with context information (step: S107). The kernel driver 200 may then transmit a return value to the application 40 (step: S108).

Meanwhile, unlike in the above description, the kernel driver 200 may create a data encryption/decryption key, request a header and a policy from the digital information manager 120 at the same time, and receive the header and the policy from the digital information manager 120 from the digital information manager 120, depending on embodiments. In this case, the kernel driver 200 may encrypt a received header and then register a context.

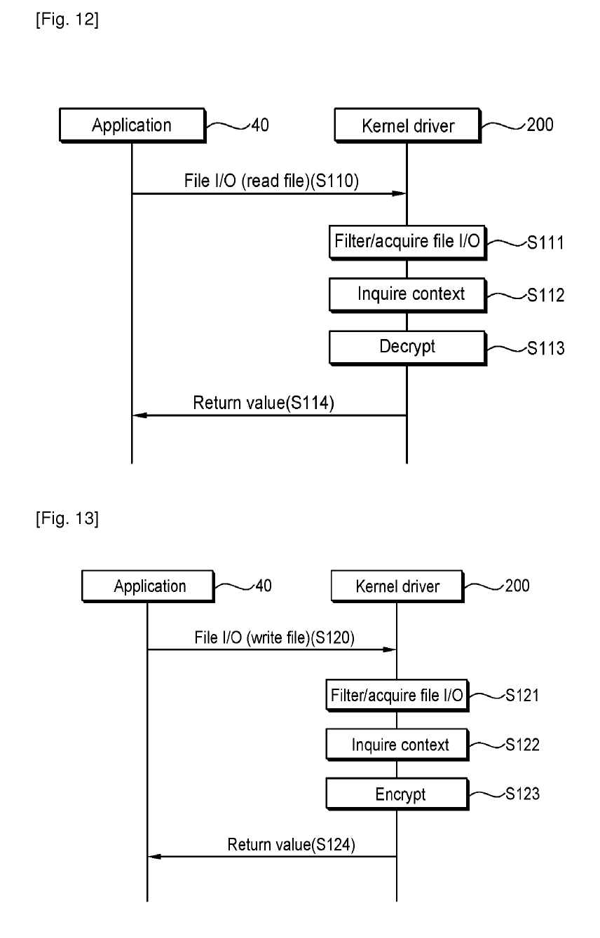

FIGS. 12 and 13 are flowcharts illustrating procedures of reading and writing a file using the digital information security system 30.

As shown in FIG. 12, if a file I/O for reading a file is generated by the application 40 in order to read the file (step: S110), the kernel driver 200 searches for and acquires the generated file I/O by continuously hooking and filtering file I/Os generated by the application 40 (step: S111).

The kernel driver 200 then inquires a context of the file (step: S112). The context may include policy information, a data encryption/decryption key, etc. of the corresponding file. After the context inquiry, the kernel driver 200 decrypts the file using the data encryption/decryption key (step: S113) and then transmits a return value to the application 40 (step: S114).

If a user requests the open of a specific file using the application 40, the file open and read procedures of the digital information security system 30 are performed sequentially. Accordingly, the user can open the file within access rights assigned thereto according to a policy.

Meanwhile, referring to FIG. 13, if a file I/O for writing a file is generated by the application 40 in order to write the file (step: S120), the kernel driver 200 searches for and acquires the generated file I/O by continuously hooking and filtering file I/Os generated by the application 40 (step: S121).

The kernel driver 200 then inquires a context of the file (step: S122). The context may include policy information, a data encryption/decryption key, etc. of the corresponding file. After the context inquiry, the kernel driver 200 encrypts the file using the data encryption/decryption key (step: S123) and then transmits a return value to the application 40 (step: S124).

As described above, according to the present invention, major security operations for protecting digital information are performed through the kernel driver 200. Accordingly, unlike in the prior art in which each security means is used in each application in a user mode, the common functions of security means provided in respective applications are configured in a kernel area as a common apparatus. Accordingly, the efficiency of a system construction can be significantly improved. Further, there is an advantage in that security can be improved because security functions are performed in a kernel area.

Although the present invention has been described in detail in connection with the preferred embodiments, a person having ordinary skill in the art will appreciate that the invention may be modified in various forms without departing from the spirit and scope of the present invention defined in the appended claims. Accordingly, a change of future embodiments of the present invention may not deviate from the technology of the present invention.

1. A digital information security system, comprising:
a user module configured to operate in a user mode and to provide environment setting information comprising policy information about a use of digital information; and
a kernel driver configured to operate in a kernel mode, to acquire information generated by an application of the user mode for the use of digital information, and to perform rights control regarding the use of digital information based on the acquired information and the policy information.

2. The digital information security system of claim 1, wherein the user module comprises:
a digital rights management (DRM) agent for storing environment setting information, received from a DRM server, in a local repository and controlling the driving of the kernel driver; and
a digital information manager configured to be inserted into the application by the DRM agent and to manage the policy information based on the stored environment setting information.

3. The digital information security system of claim 2, wherein the DRM agent comprises:
a user authentication module for authenticating a user in association with the DRM server;
an environment setting module for receiving environment setting information of the user, authenticated by the user authentication module, from the DRM server and storing the received environment setting information in the local repository;
a digital information manager injection module for, when a notice, informing creation of a process, is received from the kernel driver, injecting the digital information manager into the process, and providing an injection result and its pertinent information to the kernel driver; and
a driver control module for controlling the driving of the kernel driver.

4. The digital information security system of claim 3, wherein the policy information included in the environment setting information comprises access control information of the authenticated user.

5. The digital information security system of claim 4, wherein the access control information comprises at least any one of access rights of digital information accessible to the authenticated user for every application, a screen capturing prevention policy, a clipboard use policy, and a print policy.

6. The digital information security system of claim 3, wherein the digital information manager injection module provides at least any one of a process identifier, a process-based automatic encryption value, a process-based screen capturing prevention value, a process-based clipboard control value, and a process-based print control value to the kernel driver.

7. The digital information security system of claim 3, wherein the driver control module controls at least any one of load/unloading of the kernel driver, set/clear of the kernel driver, and activation/deactivation of a specific function of the kernel driver.

8. The digital information security system of claim 3, wherein the driver control module provides the kernel driver with at least any one of user information and policy information, an encryption-excepted extension name, a file header encryption/decryption key, and a file header encryption/decryption public key.

9. The digital information security system of claim 2, wherein the digital information manager comprises:
a user information/policy management module for acquiring data from the environment setting information stored in the local repository, managing the acquired data, and performing a user information and a policy inquiry processing at the request of a specific module;
a header management module for analyzing the header of an encrypted file or creating the header of a file to be encrypted at the request of the kernel driver, and performing a file information and policy inquiry processing at the request of the specific module;
an access control information management module for requesting information from the user information/policy management module and the header management module, and determining a policy depending on the request of the kernel driver based on information received in response to the request; and
a communication module for accessing the kernel driver and providing a communication function with the kernel driver.

10. The digital information security system of claim 9, wherein the access control information management module records log information using log data received from the kernel driver.

11. The digital information security system of claim 1, wherein the kernel driver comprises:
a kernel application program interface (API) hooking/processing module for, when a system call kernel API requiring rights control is generated by the application, hooking the system call kernel API and performing rights control based on the policy information; and
a file system hooking/processing module for hooking file inputs/outputs (I/Os) generated by the application and performing encryption or decryption of a corresponding file based on the policy information.

12. The digital information security system of claim 11, wherein the kernel API hooking/processing module comprises:
a screen capturing prevention module for hooking a system call kernel API generated by the application in connection with screen capturing and performing a capturing prevention processing based on the policy information by inquiring the policy information;
a clipboard copy prevention module for hooking a system call kernel API generated by the application in connection with clipboard copy and performing a clipboard copy prevention processing based on the policy information by inquiring the policy information; and
a print control module for hooking a system call kernel API generated by the application in connection with printing and controlling whether to perform the printing based on the policy information by inquiring the policy information.

13. The digital information security system of claim 12, wherein the kernel API hooking/processing module comprises:
a Watermark injection module for hooking a system call kernel API generated by the application in order to inject a Watermark during a print process, inquiring the policy information, and, if the Watermark needs to be injected, injecting the Watermark into a print output result; and
a print file information writing module for requesting the user module to write log information upon printing.

14. The digital information security system of claim 11, wherein the file system hooking/processing module comprises:
a context management module for performing registration, inquiry, and deletion functions of context for analysis of file I/Os and an encryption processing of files;
a file header management module for requesting a policy pertinent to a use of a file from the user module and performing a function of managing a header of a file; and
a file system hooking/processing routine module for acquiring file I/Os other than file I/Os having support-excepted extensions, while hooking and filtering file I/Os generated by the application, and performing encryption or decryption of files pertinent to the acquired file I/Os.

15. The digital information security system of claim 14, wherein the file header management module comprises at least any one of a header decryption function of decrypting an encrypted file, a header encryption function of encrypting a plaintext file, and a file analysis function of determining a type of a file through file analysis.

16. The digital information security system of claim 14, wherein the file header management module creates a data encryption key used to encrypt a file.

17. The digital information security system of claim 11, wherein the kernel driver comprises:
a control module for activating or deactivating at least any one of the kernel API hooking/processing module and the file system hooking/processing module in response to a control signal received from the user module;
a communication module for accessing the user module and providing a communication function with the user module; and
a policy POOL for storing information necessary for operations of the kernel API hooking/processing module and the file system hooking/processing module and providing the information at the request of the kernel API hooking/processing module and the file system hooking/processing module.

18. The digital information security system of claim 17, wherein:
the control module registers the information necessary for the operations of the kernel API hooking/processing module and the file system hooking/processing module with the policy POOL or deletes information from the policy POOL, and the information comprises the policy information.

19. The digital information security system of claim 17, wherein, when a process is created by the application, the control module transmits a notice, informing the creation of the process, to the user module and registers process information, received from the user module, with the policy POOL.

20. A kernel driver apparatus for performing rights control in a kernel mode, the kernel driver apparatus comprising:
a storage module for storing information;
a control module for receiving setting information, including policy information, from a specific entity of a user mode and registering the received setting information with the storage module; and
a security function module for hooking information, generated by an application of the user mode for a use of digital information and performing rights control regarding the use of the digital information using at least any one of policy information, registered with the storage module, and policy information managed in the application.

21. The kernel driver apparatus of claim 20, wherein the information generated in the kernel mode in order to use the digital information comprises at least any one of a system call kernel API and file I/Os, generated by the application.

22. The kernel driver apparatus of claim 21, wherein the security function module comprises at least any one of:
a kernel API hooking/processing module for hooking the system call kernel API generated by the application and performing rights control based on the policy information; and
a file system hooking/processing module for hooking the file I/Os generated by the application and performing encryption or decryption of a corresponding file based on the policy information.

23. The kernel driver apparatus of claim 20, wherein the rights control controls at least any one of file open, file edit, file storage, file printing, screen capturing, and clipboard copy of the digital information.

24. A digital information security method, comprising the steps of:
receiving environment setting information from a DRM server and storing the received environment setting information in a local repository;
loading a kernel driver for performing rights control;
providing the kernel driver with setting information necessary for an operation of the kernel driver based on the environment setting information; and
when the kernel driver is set according to the setting information, activating at least one of security function modules included in the kernel driver.

25. The digital information security method of claim 24, further comprising the steps of:
when a notice, informing creation of a process, is received from the kernel driver, injecting a digital information manager into the corresponding process;
providing the kernel driver with an injection result in the injection step and its pertinent information; and
the kernel driver performing rights control through a security function module in association with the digital information manager.

26. The digital information security method of claim 24, wherein the security function module controls at least any one of file open, file edit, file storage, file printing, screen capturing, and clipboard copy of digital information.

27. A digital information security method using a kernel driver operating in a kernel mode, the digital information security method comprising the steps of:
hooking an API generated by an application of a user mode for the kernel mode, wherein the API is pertinent to a use of digital information;
determining whether rights control regarding the use of digital information is necessary by inquiring preset policy information; and
if, as a result of the determination, the rights control is determined to be required, controlling use rights of the digital information based on the policy information.

28. The digital information security method of claim 27, wherein the step of hooking the API comprises the step of hooking the API generated by the application of the user mode for the purpose of screen capturing of the digital information.

29. The digital information security method of claim 28, wherein the step of controlling the use rights of the digital information comprises the step of performing a screen capturing prevention processing for preventing the screen capturing of the digital information.

30. The digital information security method of claim 27, wherein the step of hooking the API comprises the step of hooking the API generated by the application of the user mode in order to copy at least part of the digital information to a clipboard.

31. The digital information security method of claim 30, wherein the step of controlling the use rights of the digital information comprises the steps of:
prohibiting the copy to the clipboard; and
outputting a message, informing that the copy has not been permitted.

32. The digital information security method of claim 27, wherein the step of hooking the API comprises the step of hooking the API generated by the application of the user mode in order to request printing of the digital information.

33. The digital information security method of claim 32, wherein the step of determining whether the rights control is necessary comprises the steps of:
requesting a print policy of a user from a digital information manager injected into the application; and
receiving the print policy from the digital information manager.

34. The digital information security method of claim 33, wherein the step of controlling the use rights of the digital information comprises the step of performing or prohibiting the printing of the digital information based on the received print policy.

35. A digital information security method using a kernel driver operating in a kernel mode, the digital information security method comprising the steps of:
acquiring a specific file I/O by filtering file I/Os generated by an application of a user mode;
analyzing a file of the acquired file I/O; and
if, as a result of the analysis, the file is an encrypted file, decrypting a header of the file and then requesting a policy for rights control from a digital information manager of the user mode, and, if, as a result of the analysis, the file is a plaintext file, creating a data encryption key for encrypting the file and then requesting at least any one of a header of the file and a policy for rights control of the file from the digital information manager.
